(19) United States
(12) Patent Application Publication
(10) Pub. No.: US 2018/0132485 A1
(43) Pub. Date: May 17, 2018

(54) USE OF HYDROXYAPATITE AS A CARRIER OF NUTRITIONAL ELEMENTS AND VEGETAL EXTRACTS FOR TREATING PLANTS

(71) Applicant: NDG NATURAL DEVELOPMENT GROUP S.R.L., Castel Maggiore (bologna) (IT)

(72) Inventors: Gianluca Manfredini, Castel Maggiore (bologna) (IT); Massimo Piva, Castel Maggiore (bologna) (IT); Matteo Coletti, Moscow (RU); Enrico Battiston, Musile Di Piave (venezia) (IT)

(73) Assignee: NDG NATURAL DEVELOPMENT GROUP S.R.L., Castel Maggiore (bologna) (IT)

(21) Appl. No.: 15/574,279

(22) PCT Filed: May 17, 2016
(86) PCT No.: PCT/IB2016/052861

§ 371 Date: Nov. 15, 2017

(30) Foreign Application Priority Data
May 18, 2015 (IT) 102015000015572

(51) Int. Cl. A01N 59/26; A01N 25/08; A01N 59/20; A01N 65/22; A01N 65/28; A01N 65/48; C01B 25/32

(52) U.S. Cl. CPC A01N 59/26; A01N 25/08; A01N 59/20; C01B 25/32; A01N 65/28; A01N 65/48; A01N 65/22

(57) ABSTRACT

The subject matter of the invention is a substituted hydroxyapatite carrier, responding to the formula: Ca₍₁₀₋ₓ₎Mₓ(PO₄)_{(6-y)}(CO₃)_{y}(OH)₂ in which: M is chosen from Cu, Mg, Zn, Pb, Cd, Ba, K, Mn, Mo, Fe, Ag, B, Se or a combination of at least two of such elements; —x is comprised between 0 and 2, preferably between 0 and 1, more preferably between 0 and 0.8, even more preferably between 0.02 and 0.05; —y is comprised between 0 and 2, preferably between 0 and 1, more preferably between 0.002 and 0.030, with the proviso that x and y are never equal to 0 at the same time. The substituted hydroxyapatite is a carrier of a bioactive substance chosen among a metal ion selected from Mn, Mg, K, Fe, B, Mo, Se and/or an extract of vegetal origin. The invention relates also to the use of the carrier for the delivery of such a bioactive substance to plants in order to achieve the phytosanitary and/or nutritional treatment of the plant.

### FIELD OF THE INVENTION

The present invention relates to the use of hydroxyapatite. as a carrier of bioactive substances, in particular vegetal extracts and/or nutritional elements, for the phytosanitary and/or nutritional treatment of plants, preferably grapevines.

### BACKGROUND ART

In agriculture, there is a precarious balance between biotic agents such as fungi, bacteria, phytoplasma, viruses and parasites and the actual defences of the plant in question.

In fact, plants generally have a resistance called pre-infection resistance in the sense that they have physical barriers, like their membrane walls, or chemical barriers obtained by the production and diffusion of antimicrobial substances. Plant resistance can be sufficient by itself and thus not require any treatment.

However, certain pathogens bring about an imbalance and plants are no longer able to defend themselves with their own mechanisms.

In order to help the plant natural defences to fight against diseases, the delivery of nutritional elements is becoming an essential part of the plant protection strategy, aiming at keeping the plant in the best nutrition balance, fundamental prerogative to prevent any disease development. Potassium is a key element, through the potassium/nitrogen ratio, in the reduction of fungal diseases, such as botrytis, in grapevine. When leaf nitrogen levels are high, plant growth increases and the concentration of plant exudates (e.g. sugar and amino acids) in the fruit rises. The combination with low potassium-levels (N/K ratio over 2.5) stimulates spreading of the disease on leaves and fruit. Magnesium sustains the healthy growth and development of crop. Magnesium is a constituent of the structural tissues and is involved in physiological functions and biochemical processes. Application of magnesium fertilizers resulted in decrease of bunch stem necrosis. Iron takes part to important metabolic activities during respiration, DNA synthesis and photosynthesis. All these processes play major roles in the disease defence systems of crop. Manganese can provide opportunity for direct and indirect effects on defence mechanism of crop, being involved in the metabolism of carbohydrate and nitrate. Molybdenum is involved in synthesis or regulation of hormones and its deficiency limits the growth of crop. Boron contribution in lignification and phenol metabolism reveals its benefit in the crop defence mechanism against diseases.

Next to this approach, the application of extracts of vegetal origin, also known as “botanicals”, is included among the sustainable strategies of plant protection.

Many vegetal extracts show a broad spectrum of activity against pest insects and plant pathogenic fungi ranging from insecticidal, antifeedant, repellent, oviposition deterrent, growth regulatory and antivector activities.

Vegetal extracts are a mixture of natural substances derived from various parts of plants, mainly seeds, but also fruits (olive) and other parts of plants (e.g. leaves). They are a very heterogeneous group of products of natural origin, in the form of hygroscopic powder, alcoholic and hydro-alcoholic solution. Some vegetal substances were included in Annex I of Directive 91/414/EEC with specific provisions (Directive 2008/127/EC): rapeseed extract as insecticide and acaricide, citronella extract as herbicide, and melaleuca alternifolia (tea tree extract) as fungicide.

Other edible vegetable extracts (peanut, safflower, cotton, sunflower, flax, corn, olive, coconut palm, mustard, sesame, soy and grape seed) that should result from mechanical extraction and be handled exclusively by physical processes were not included in Annex I and in Italy they can be used as biostimulants, plant strengthener and enhancers of the natural defences of plants (DL 55/2012).

In the fields of plant protection and phytosanitary treatment of plants, there is still the need of improving the delivery (and thus the bioavailability) of vegetal extracts and nutritional elements to plants, with the aim to safeguard plant health while, at the same time, reducing the administration doses of such extracts, which are valuable substances from an economic point of view.

Hydroxyapatite is well known in the prior art in different forms and for different applications. For example, synthetic hydroxyapatite constitutes an excellent biomaterial for biomedical applications, notably for bone reconstruction.

Hydroxyapatite and synthetic substituted hydroxyapatite can be produced by different processes, by wet, hydrothermal, electrochemical, sol-gel or solid state synthesis. It can be found in different stoichiometric, morphological and crystalline forms.

Carriers of stoichiometric hydroxyapatite are known from JPH0556105 which describes the use of hydroxyapatite as a carrier for an antimicrobial metal ion selected from silver, copper and zinc to sterilize a soil from the presence of the plant pathogenic fungus Pythium. The action of the antimicrobial metal ion is limited to the soil since the publication specify that the agent is hardly absorbed into the plant.

EP0640284 describes an antimicrobial sand coated with a stoichiometric hydroxyapatite carrier containing antimicrobial agents, such as silver, copper or zinc ions. The antimicrobial sand is mixed with the soil used to grow flowering plants, such as orchids, cyclamen etc., to sterilize the soil against the fungi: Rhizoctonia, Fusarium, Sclerotinia and Pyshium.

RO 122830 describes a fungicide composition, based on salts of N,N-ethylene-bis-thiocarbamic acid, characterized by the fact that it consists of 40-50% zinc N,N-ethylene-bis-thiocarbamate or a mixture thereof with the manganese salt or manganese and iron salt, 30-50% hydroxyapatite, 1.5-3% SiO₂ and 20-50% potassium acetate. Prior art JPH0556105 and EP 0 640 284 does not describe the use of substituted hydroxyapatite as a carrier of active principles. Prior art does not describe the use of hydroxyapatite as carrier of active substances for the treatment of plant pathologies by application of the carrier on the plant. Prior art teaches only a way to sterilize the soil used to grow the plants, in particular flowering plants (not crops).

Prior art RO 122830 does not describe hydroxyapatite as carrier of nutritional elements, such as K, Mg, Fe, Mn, Mo, B and Se and/or as carrier of vegetal extracts, nor that hydroxyapatite can be substituted with metal ions in the Ca, PO₄ and/or OH ion positions.

### SUMMARY OF THE INVENTION

With respect to the known use of stoichiometric hydroxyapatite (i.e. hydroxyapatite base on calcium-phosphate ions not substituted by other ions), having the formula:

Ca₁₀(PO₄)₆(OH)₂

as a carrier of metal ions for sterilizing soil used to grow plants, the present invention provides the use of substituted hydroxyapatite as a carrier of (i.e. loaded with) bioactive substances chosen among metal ions such as Mn, Mg, K, Fe, B, Mo, Se (acting as fertilizers and nutritional elements), and extracts of vegetal origin, such as extracts of: lignin, mint, thyme, rosemary, sesame, soya, cloves, garlic, lemon, cinnamon, Abies sibirica, Malpighia glabra, Achillea millefolium. Allium sativum, Medicago sativa, Aloe vera Citrus sinensis, Artemisia annua, Arnica Montana, Ocimum basilicum, Betula pendula, Betula pubescens, Calendula officinalis, Matricaria chamomilla, Chamaemelum nobile, Cinnamomum verum, Centella asiatica, Chelidonium majus, Syzygium aromaticum, Allium cepa, Equisetum arvense, Curcuma longa, Echinacea purpurea, Echinacea angustifolia, Eucalyptus globulus, Hypericum perforatum, Fucus vesiculosus, Gentiana lutea, Lavandula angustifolia, Citrus limon, Melilotus officinalis, Melissa officinalis, Punica granatum, Mentha piperita, Vaccinium myrtillus, Orthosiphon stamineus, Urtica dioica, Olea europeae, Tabebuia impetiginosa, Plantago lanceolata, Hieracium pilosella, Pinus sibirica, Polypodium leucotome, Citrus paradise, Quassia amara, Rheum Thais, Rosa canina, Rosmarinus officinalis, Ruscus aculeatus, Salix alba, Salvia officinalis, Camelia sinensis, Tilia tomentosa, Thymus vulgaris, Arctostaphylos uva-ursi, Valeriana officinalis, Solidago virgaurea, Loranthus europaeus, Zingiber officinale.

The vegetal extracts can have both nutritional activity and mild anti-parasite activity.

The invention provides also for the use of hydroxyapatite as a carrier of (i.e. loaded with) a mixture of the vegetal extracts listed above or a mixture of metal ions listed above or a mixture of metal ions and vegetal extracts.

The invention also provides for the use of a composition of the hydroxyapatite carrier of the invention and one or more bioactive substances according to the invention for treating plants.

The use of substituted hydroxyapatite as carrier of (i.e. loaded with) a bioactive substances according to the invention is intended for treating plants, preferably for the phytosanitary and/or nutritional treatment of plants, in particular of the grapevines. Other plants that can be treated according to the invention are: tomato plant (Solanum lycopersicum), wheat (Triticum spp), pear tree (Pyrus spp), apple tree (Malus domestica), olive tree (Olea europaea), kiwifruit (Actinia spp) and vegetable plants, such as lettuce, spinach, cucurbits (for example cantaloupe, cucumber, pumpkin, squash and watermelon), onion, leek, peas.

The hydroxyapatite used as a carrier of bioactive substances is substituted with at least one ion selected from carbonate ion or a metal ion. The carbonate substitution can be in the phosphate site of hydroxyapatite (site B) and/or in the hydroxyl site (site A). The metal ion substitution is in the calcium site.

The hydroxyapatite of the invention can be substituted by both at least one carbonate ion and at least one metal ion. The metal ion is preferably selected from: Mg, Zn, Pb, Cd, Ba, K, Mn, Cu, Mo, Fe, Se, Ag and B. Preferably, the hydroxyapatite used as carrier of bioactive substances for the treatment of plants, is hydroxyapatite substituted with at least one carbonate ion and no further metal ions.

The hydroxyapatite carrier loaded with at least one bioactive substance is applied on the plants and penetrates into the plants through natural openings, as explained in details below, thus realizing an intimate contact with the pathogen cells that can be present both on the plant surface or inside the plant.

The hydroxyapatite carrier loaded with at least one bioactive substance is used for treating plants according to the invention.

The carbonate substitution, but also the metal ion substitution, has the advantage to lower the crystallinity degree of hydroxyapatite, which thus becomes more amorphous. The amorphous state leads to an increase of solubility of the hydroxyapatite in a biological environment, with the advantage that the bioactive substances release is improved and becomes more effective. Thus, lower doses of bioactive substances can be used with respect to the administration of a bioactive substance without the hydroxyapatite carrier.

The invention refers also to a carrier of substituted hydroxyapatite having the above characteristics, comprising a bioactive substance adsorbed thereto, thus yielding a hydroxyapatite loaded with at least one active substance.

### BRIEF DESCRIPTION OF THE DRAWINGS

FIGS. 1 to 4 show the results of the tests included in the section “examples A”:

FIG. 1 shows the results of the first laboratory test on Agrobacterium vitis.

FIG. 2 shows the results of the second laboratory test on Agrobacterium vitis.

FIG. 3 shows the results of the first laboratory test on Botrytis cinerea.

FIG. 4 shows the results of the second laboratory test on Botrytis cinerea.

FIGS. 5 to 8 show the results of the tests included in the section “examples B”:

FIGS. 5A-D show the results of the laboratory test on Botrytis cinerea.

FIGS. 6A-D show the results of the laboratory test on Phaeomoniella chlamydospora.

FIG. 7A-D show the results of the laboratory test on Phaeoacremonium aleophilum.

FIG. 8A-D shows the results of the greenhouse test on Plasmopara viticola.

### DETAILED DESCRIPTION OF THE INVENTION

With “substituted hydroxyapatite” in the present invention, it is intended to refer to hydroxyapatite of the formula Ca₁₀(PO₄)₆(OH)₂ in which the Ca, PO₄ and/or OH ions are replaced, in the crystal lattice of hydroxyapatite, with one or more ions of the same or different species.

For the scope of the present invention, “hydroxyapatite functionalized with a bioactive substance” is a definition equivalent to say that the bioactive-substance is “adsorbed” or “loaded” on the hydroxyapatite and also equivalent to say that hydroxyapatite is a carrier of bioactive substances.

With “vegetal extract” in the present invention it is intended to refer to a mixture of natural substances derived from the mechanical or chemical treatment of various parts of plants, mainly seeds, but also fruits (in particular peel or skin of the fruits) and other parts of plants (e.g. leaves). The vegetal extracts according to the invention are preferably prepared using a chemical method of treating seeds, flower, leaves, fruits (in particular the peel or skin of the fruits) (or other parts of the plants) with an alcoholic and/or hydro-alcoholic solution and then removing the solvent to obtain a hygroscopic powder. The vegetal extracts of the invention can be used either in the form of a powder or in the form of an alcoholic or hydro-alcoholic solution.

With “bioactive substance” in the present invention it is intended to refer to substances that have a nutritional activity and/or a phytosanitary activity. For “phytosanitary treatment” or “phytosanitary activity” it is intended the treatment or prevention of plant diseases caused by parasites such as cryptogams, bacteria, fungi, phytoplasma and insects.

For “nutritional treatment” or “nutritional activity” it is intended to refer to bioactive substances that help the development of the plant natural defences (and thus help plants to fight against diseases), keeping the plant in the best nutrition balance, fundamental prerogative to prevent any disease development.

The bioactive substance used in the invention can have both a phytosanitary activity and a nutritional activity and thus can be used for both phytosanitary and nutritional treatment of the plants, depending on the dosage of use.

The present invention relates to the use of substituted hydroxyapatite as a carrier of bioactive substances (i.e. loaded with a bioactive substance) for the phytosanitary treatment and/or nutritional treatment of plants, in particular of grapevines. The invention is suitable for treating all types of plants, particularly for treating grapevines. Other plants that can be treated according to the invention are: tomato plant (Solanum lycopersicum), wheat (Triticum spp), pear tree (Pyrus spp), apple tree (Malus domestica), olive tree (Olea europaea), kiwifruit (Actinia spp) and vegetable plants, such as lettuce, spinach, cucurbits (for example cantaloupe, cucumber, pumpkin, squash and watermelon), onion, leek, peas.

Preferred diseases treated with the product of the invention are: downey mildew (caused by Plasmopara viticola), powdery mildew (caused by Erysiphe nectar), grey mould (caused by Botrytis cinerea), black rot (caused by Guignardia bidwellii), grapevine crown gall (caused by Agrobacterium vitis), grapevine trunk diseases or esca (caused by Botryosphaeriaceae, Phaeomoniella chlamydospora, Phaeoacremonium aleophilum, Fomitiporia mediterranea) late blight of tomatoes (caused by Phytophthora infestans), fusarium head blight of wheat (caused by Fusarium graminearum and Fusarium culmorum), apple scab (caused by Venturia inaequalis), pear scab (caused by Venturia pirina), brown spot of pear (caused by Stemphylium vesicarium), Lettuce mildew (caused by Bremia lactucae), Spinach mildew (caused by Peronospora spinaceae), Cucurbits mildew (caused by Pseudoperonospora cubensis on cantaloupe, cucumber, pumpkin, squash and watermelon), Onion mildew (caused by Peronospora schleideni), Leek mildew (caused by Phytophtora porri), Peas mildew (caused by Peronospora pisi), diseases caused by the insects: European grapevine moths (Eupoecilia ambiguella) and vine mealybug (Planococcus ficus).

Preferably, the hydroxyapatite is substituted with at least one carbonate ion or at least one metal ion or with both at least one carbonate ion and at least one metal ion.

In a preferred embodiment, the substituted hydroxyapatite carrier of the invention has the following formula:

Ca₍₁₀₋ₓ₎Mₓ(PO₄)_{(6-y)}(CO₃)_{y}(OH)₂

where:
M is chosen from Cu, Mg, Zn, Pb, Cd, Ba, K, Mn, Mo, Fe, Ag, B, Se or a combination of at least two of such elements;
x is comprised between 0 and 2, preferably between 0 and 1, more preferably between 0 and 0.8, even more preferably between 0.02 and 0.05;
y is comprised between 0 and 2, preferably between 0 and 1, more preferably between 0.002 and 0.030,
   with the proviso that x and y are never equal to 0 at the same time.

The hydroxyapatite included in the above formula can be substituted with carbon ions only or metal ions only or a mixture of carbonate and metal ions.

In a preferred embodiment, the hydroxyapatite carrier of the invention is substituted by at least one carbonate ion (and no other metal ion), and has the following formula:

Ca₍₁₀₎(PO₄)_{(6-y)}(CO₃)_{y}(OH)₂

wherein y is comprised between 0 and 2, preferably between 0 and 1, more preferably between 0.002 and 0.030.

The carbonate substitution can occupy site B (PO₄³⁻ phosphate ions) as per general formulae above and/or site A (OH hydroxyl ions) of the hydroxyapatite. The ratio of substitution on site A/substitution on site B is comprised between 0.10 and 0.60 and even more preferably the ratio is comprised between 0.20 and 0.40.

In the hydroxyapatite structures considered in the present invention, the substitution is preferably on site B, with a percentage of carbonate occupying the B site that is greater than or equal to 55% in weight, even more preferably comprised between 90 and 100% in weight of the total weight of carbonate contained in the hydroxyapatite.

The overall content of carbonate in the hydroxyapatite according to the invention can be from 1 to 20%, preferably from 5 to 15% in weight of the total hydroxyapatite structure. The carbonate ion, preferably at site B, and the metal ion substitutions are very significant since they allow the whole hydroxyapatite structure to increase its solubility in a biological environment.

According to a preferred embodiment the above substituted hydroxyapatite has a crystallinity degree comprised between 25 and 75%, preferably between 25 and 40%. Preferably, the hydroxyapatite carrier is in the form of particles smaller than 2 μm, preferably sized between 0.2 and 0.9 μm. The hydroxyapatite particles are preferably joined together to create aggregates of hydroxyapatite particles (also referred to in this application as “clusters” or “crystals” or “microcrystals” or “microcrystalline aggregates”, all these terms having the same meaning as “aggregates” according to the invention). These aggregates have micrometric dimensions, with a size comprised between 0.5 and 25 μm, more particularly between 0.5 and 5 μm and having a significant surface area. In particular, hydroxyapatite aggregates useful according to the present invention have a surface area comprised between 60 and 120 m²/g, more particularly between 70 and 90 m²/g.

The aggregates of hydroxyapatite have the advantage of a larger surface area with respect to single hydroxyapatite particles and therefore allows adsorbing more bioactive substances and controlling the release of them in the environment. Thus for a small quantity of hydroxyapatite it is possible to transport a significant number of bioactive substances which allows the activity and biological effectiveness of the substances to be increased further.

The bioactive substances adsorbed on the hydroxyapatite carrier of the invention are chosen among metal ions such as Mn, Mg, K, Fe, B, Mo, Se (acting as fertilizers and nutritional elements), and extracts of vegetal origin, such as extracts of: lignin, mint, thyme, rosemary, sesame, soya, cloves, garlic, lemon, cinnamon, Abies sibirica. Malpighia glabra Achillea millefolium. Allium sativurn, Medicago sativa, Aloe vera Citrus sinensis, Artemisia annua, Arnica Montana, Ocimum basilicum, Betula pendula, Betula pubescens, Calendula officinalis, Matricaria chamomilla, Chamaemelum nobile, Cinnamomum verum, Centella asiatica, Chelidonium majus, Syzygium aromaticum, Allium cepa, Equisetum arvense, Curcuma longa, Echinacea purpurea, Echinacea angustifolia, Eucalyptus globulus, Hypericum perforatum, Fucus vesiculosus, Gentiana lutea, Lavandula angustifolia, Citrus limon, Melilotus officinalis, Melissa officinalis, Punica granatum, Mentha piperita, Vaccinium myrtillus, Orthosiphon stamineus, Urtica dioica, Olea europeae, Tabebuia impetiginosa, Plantago lanceolata, Hieracium pilosella, Pinus sibirica, Polypodium leucotoms, Citrus paradise, Quassia amara, Rheum Thais, Rosa canina, Rosmarinus officinalis, Ruscus aculeatus, Salix alba, Salvia officinalis, Camelia sinensis, Tilia tomentosa, Thymus vulgaris, Arctostaphylos uva-ursi, Valeriana officinalis, Solidago virgaurea, Loranthus europaeus, Zingiber officinale.

The vegetal extracts can have both nutritional activity and mild anti-parasite activity.

The bioactive molecules are adsorbed on to the hydroxyapatite carrier, thus obtaining a hydroxyapatite carrier loaded with at least one active substance.

The absorption of such substances on hydroxyapatite can be performed by all processes known to a person skilled in the art. The crystallised hydroxyapatite aggregate has an inner zone that is purely crystalline and an outer peripheral zone with electrical charges that are not completely neutral, which allows the bioactive substances to be retained.

In the case of adsorption of Mn, Mg, K, Fe, B, Mo, Se on hydroxyapatite, the adsorption can be obtained:
for Mn starting from: Manganese sulfate.
for Mg starting from: Magnesium sulfate. Magnesium oxide,
for K starting from: Potassium chloride, Potassium sulfate.
for Fe starting from: Iron sulfate.
for B starting from: Boric acid.
for Mo starting from: Sodium molybdate.

For the use according to the invention, the hydroxyapatite loaded with al least one bioactive substance is preferably integrated into a composition, preferably in the form of microcrystalline aggregates. This composition may be in all forms, notably powder, granules, liquid or gel. According to a preferred embodiment, aggregates of hydroxyapatite are dispersed in a uniform way in water. The pH of the composition in liquid form is preferably greater than 5 so as to prevent that the microcrystals of hydroxyapatite undergo partial or total hydrolysis.

Such a liquid composition allows foliar application, in particular by spraying. The structure and micrometric size of the hydroxyapatite crystals allows uniform dispersion of hydroxyapatite crystals within the volume of the micronised droplets during spraying, thus allowing good distribution throughout the total volume used for application and consequently more uniform distribution on the application surface. According to the type of atomiser used for the application of hydroxyapatite, it is possible to have droplets whose diameter varies between 50 and 800 μm. In order to avoid or limit drifting of very small droplets and discharge of very large droplets, and to guarantee better application on the surface to be treated, it is possible to use spraying means that allow droplets sized between 150 and 250 μm to be obtained.

Once applied, the aggregated particles adhere to the leaf without needing to use anti-stripping agents in the composition. In fact, according to their surface, their size, their morphological irregularities and their electrostatic characteristics, the hydroxyapatite crystals cling onto the surface of the leaves, thus ensuring optimal adhesion resistance to run off water, unlike currently existing products that are carried away by rain or dew. The use of the compositions, applied per hectare, is to be adapted according to the climatic conditions encountered, the season and the protection and nutrition strategies of the soil. By way of example for a vineyard, a suitable example of use corresponds to a quantity of water used in the order of 250 I/ha for fully developed plants, with a density in the order of 4000 stumps/ha, in variable concentration, formulated from 2.5 to 5% in particles of hydroxyapatite in weight in relation to the total weight of the liquid composition.

Once applied to the plant, the bioactive molecules may be directly released or the hydroxyapatite microcrystals may transport these substances into the intercellular spaces. Bioactive molecules are thus released by hydrolysis, in proximity to targets, in particular in proximity to target parasites such as fungi and bacteria.

In fact, the microcrystalline aggregates of hydroxyapatite penetrate into the plant according to passive diffusion following the discharge of fluids, such as carbon dioxide and water, through the natural openings of the plant tissues. Inside the plant, the hydroxyapatite behaves like a “sol-gel”: it is not stagnant in a liquid medium, it moves in the xylem and the phloem by following the circulating lymph. Hence there is no risk of accumulation in the plant. When the hydroxyapatite meets a pathogen, the aggregate decomposes as the more acidic wall of the microorganism promotes dissolution and the release of bioactive substances, which can therefore act against the pathogen.

The bioactive molecules (for example, phosphorus, calcium and carbonate) follow the lymphatic flow and exercise their activity in particular as fertilisers for improving the development of the plant and/or reinforcing its natural defences. Unlike the conventional methods, there is therefore no action on the intracellular metabolic pathways, but a contact action between the functional elements of the hydroxyapatite aggregates and the pathogens on an intercellular level or at the surface of the plants.

The bioactive substances can therefore act when they are sprayed onto the surface but also in depth into the core of the plant tissues treated.

The hydroxyapatite carrier loaded with at least one bioactive substance can also be used for application on the trunk, on the wood of plants or on their roots according to the aim of the application.

According to another aspect, the invention relates to hydroxyapatite particles loaded with at least one bioactive substance. In other words, the invention refers to a carrier of hydroxyapatite particles (or aggregates) comprising bioactive substances adsorbed thereto. The bioactive substances are those listed above.

The invention also relates to aggregates of hydroxyapatite particles as described above. These clusters have a size comprised between 0.5 and 25 μm, preferably comprised between 0.5 and 5 μm.

The invention also relates to a composition comprising at least one hydroxyapatite particle or at least one aggregate of hydroxyapatite particles according to the invention, loaded with bioactive substances. Preferably, such a composition comprises between 5 and 70% in weight of hydroxyapatite particles and/or aggregates in relation to the total weight of the dry material of the composition, even more preferably between 6 and 60%. The invention is now illustrated by manufacturing process examples, composition examples and uses examples.

### Manufacturing Example 1

The hydroxyapatite is synthesised by mixing phosphoric acid with a composition comprising calcium hydroxide and calcium carbonate previously dispersed in a suitable quantity of water.

The reaction requires about 12 to 48 hours, more particularly about 15 to 30 hours. Following the suspension of microcrystals a suspension of vegetal extracts such as extracts of mint, thyme, rosemary, cloves, cinnamon, lemon and garlic is added, previously dissolved in a suitable quantity of water.

Once these two solutions are combined, they are mixed to allow adsorption of vegetal extracts in the hydroxyapatite.

The of the copper solution takes about 12 to 72 hours, more particularly from 24 to 60 hours.

### Manufacturing Example 2

The hydroxyapatite is synthesised by mixing phosphoric acid with a composition comprising calcium hydroxide and calcium carbonate, previously dispersed in a suitable quantity of water.

The reaction requires about 12 to 48 hours, more particularly about 15 to 30 hours. Following the suspension of microcrystals, a formulation of micro-elements such as boric acid and magnesium oxide is dispersed in a suitable volume of water is added. Once these two solutions are combined, they are mixed to allow adsorption of the metal ions in the hydroxyapatite.

The reaction requires about 2 to 10 hours, more particularly about 4 to 6 hours.

### Manufacturing Example 3

The hydroxyapatite is synthesised by mixing phosphoric acid with a composition comprising calcium hydroxide and calcium carbonate, previously dispersed in a suitable quantity of water.

The reaction requires about 12 to 48 hours, more particularly about 15 to 30 hours. Following the suspension of microcrystals, a suspension of vegetal extracts such as the alcoholic or hydro alcoholic extract (in form of hygroscopic powder) of Citrus paradisi, Loranthus europaeus, Medicago sativa and Solidago virgaurea, is dispersed in a suitable volume of water is added.

Once these two solutions are combined, they are mixed to allow adsorption of the extracts in the hydroxyapatite.

The reaction requires about 2 to 10 hours, more particularly about 4 to 6 hours.

### Composition Examples

A selenium based composition may comprise the following formulation:
Selenium hydroxyapatite 10% (carbonate hydroxyapatite with selenium ions adsorbed thereto)
Distilled water 83%
Xanthan gum 1%
Glycerine 4%
Benzoic acid 2%

A Boron based composition may comprise the following formulation:
Boron hydroxyapatite 10% (carbonate hydroxyapatite with boron ions adsorbed thereto)
Distilled water 83.5%
Xanthan gum 1%
Glycerine 4%
Benzoic acid 1.5%

A composition according to the invention may also be a composition comprising a mixture of the two compositions previously described.

### Example of Use

In order to optimise the functional properties and structural stability of the liquid compositions comprising the hydroxyapatite particles, a use can be implemented according to the following recommendations in particular:
Shaking the composition before use to put the particles and/or aggregates of particles back in suspension in the composition;
Using an atomiser that ensures complete and uniform wetting of the vegetation and prevents too low or too high volumes;
Using quantities of water ranging from 60 L/ha to 250 L/ha on fully developed plants, avoiding excessive amounts of water which create run off;
Reducing the amount of product per hectare in the event of manual application;
Controlling the pH of the solution in water so that it is greater than 5.

### Examples A

Experimental Tests on Vine Diseases

LEGEND OF THE TESTED FORMULATIONS
All the formulations contain water, hydroxyapatite
substituted with carbonate ions and/or copper and/or zinc,
and loaded with ions (K, Mg, B, Mn) and/or vegetal extracts.

| Code | Functional (F) or substituent (S) substances (g/kg formulation) |
|---|---|
| C1 | Cu = 50 (S); Zn (S) = 18; mix of vegetal extracts = 30 (F) |
| C2 | Vegetal extract of Lemon = 30 (F) |
| C3 | Vegetal extract of Cloves = 30 (F) |
| C4 | Vegetal extract of Peppermint = 30 (F) |
| C5 | Vegetal extract of Thyme = 30 (F) |
| C6 | Vegetal extract of Rosemary = 30 (F) |
| C7 | Vegetal extract of Garlic = 30 (F) |
| C8 | Vegetal extract of Cinnamon = 30 (F) |
| C9 | mix of vegetal extracts = 30 (F) |

1. Introduction

Several formulations based on hydroxyapatite substituted with carbonate ions and/or copper and/or zinc, and loaded with vegetal extracts were tested in vitro against grapevine pathogens.

2. Grapevine Crown Gall (Agrobacterium vitis)

The biological efficacy of the test agents was determined in terms of inhibition of the growth. To this aim 6 strains of Agrobacterium vitis from different growing areas worldwide, were grown in vitro. The strains of A. vitis, were inoculated on Petri dishes containing PDA (Potato Dextrose Agar), in the ratio of approximately 10 to 8 cells. After plating the bacteria, 5 holes (6 mm) were drilled in the substrate (one at the center of the plate and 4 equally spaced around the central hole). Each plate was filled with 20 microliters of test substance at the concentrations indicated; for each substance and concentration, 3 replies were set up. The central hole was filled with 20 microliters of sterile water, which represented the untreated control. The plates were incubated at 28° C., for 2-5 days.

After the expiration of the incubation period, for each tested strain and for each substance and concentration, the diameters of the inhibitory zones were considered (average of two orthogonal diameters of each inhibitory area). The collected data were subjected to analysis of variance ANOVA and comparison of averages with SNK test.

In the first test, the biological efficacies of the following treatments were compared:
NT—Control (water): the growth was not inhibited.
CA—Sodium Hypochlorite (3% v/v): the growth was completely inhibited.
C1: the growth was inhibited by augmenting the % from 1 to 10, obtaining the most similar effect to the Control Agent.
C9: the growth the growth was inhibited by augmenting the % from 1 to 10, obtaining the similar effect of C1. The highest concentration is not significantly different from the highest concentration of C1.

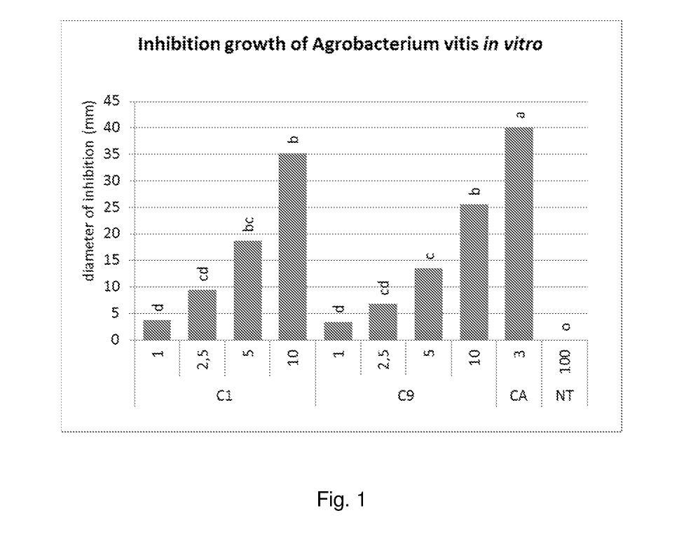

See FIG. 1 for a schematic view of the results.

In the second test, the biological efficacies of the following treatments were compared:
NT—Control (water): the growth was not inhibited.
CA—Sodium Hypochlorite (3% v/v): the growth was completely inhibited.
C2: the growth was inhibited by augmenting the % from 1 to 10. The highest concentration is not significantly different from the highest concentration of C3 and C7.
C3: the growth the growth was inhibited by augmenting the % from 1 to 10. The highest concentration is not significantly different from the highest concentration of C3 and C7.
C4: the growth the growth was inhibited by augmenting the % from 1 to 10.
C5: the growth the growth was inhibited by augmenting the % from 1 to 10.
C6: the growth the growth was inhibited by augmenting the % from 1 to 10.
C7: the growth the growth was inhibited by augmenting the % from 1 to 10. The highest concentration is not significantly different from the highest concentration of C2 and C3.
C8: the growth the growth was inhibited by augmenting the % from 1 to 10.

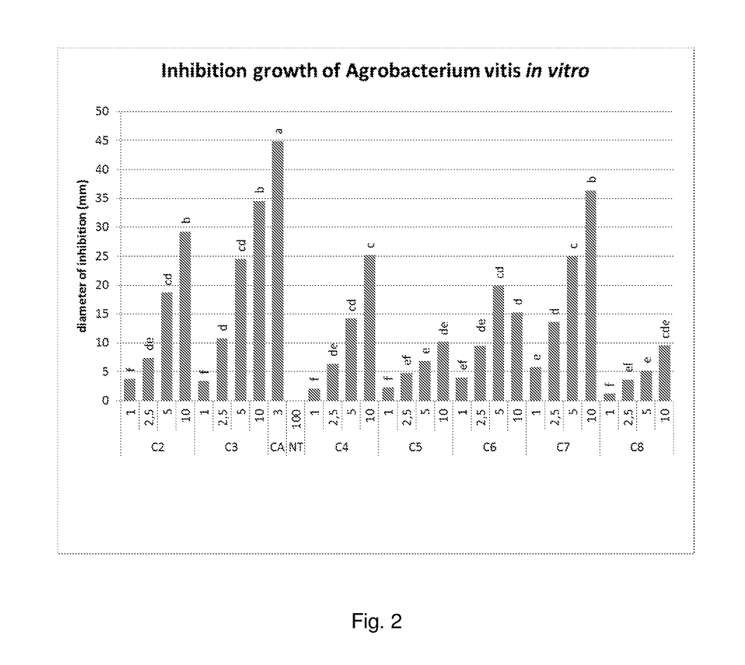

See FIG. 2 for a schematic view of the results.

2. Grey Mould (Botrytis cinerea)

The biological efficacy assessment of test agents against Botrytis cinerea was performed only in laboratory by a test in vitro. To this aim, several microscope slides were immersed in a beaker containing water agar medium and then placed into petri dishes.

The inoculum of conidia was prepared selecting three cultures (petri dishes) of Botrytis cinerea: 10 ml of distilled water were poured in each petri dish and smeared by a spatula over the entire surface of the mycelium. The conidia suspension obtained was filtered through a sterile plastic tube filled with fiberglass in order to separate parts of mycelium from conidia. The conidia concentration was adjusted to 1*10⁶ conidia/ml (minimum) by counting in a Thoma® chamber at the microscope (magnification 40×) eventually achieved diluting with distilled water. Once the water agar medium was solidified on the microscope slides, 50μ1 of the conidia suspension were filled on each microscope slide, over which, 50μ1 of the solution representing each factor (water, comparison agent and test agent) was added on the agar surface. Finally, the microscope slides were covered with cover slips. Six petri dishes were prepared per each factor.

The petri dishes were incubated in a humid box at 25° C. (day/night intervals 12/12). After 48 hours they were observed on the microscope (magnification 40×). The biological efficacy of the test agents was determined in terms of conidia germination, evaluating the ratio between non-germinated conidia (inactive or degenerated) and germinated conidia (active having issued the germination tube) of one hundred conidia. In the first test, the biological efficacies of the following treatments were compared after 20 hours:
Control (water): a very high absolute number of germinated conidia was noted.
Switch® (a.i. Cyprodinil and Fludioxonil) (0.194% p/v): a low absolute number of germinated conidia were observed;
C1: a very low absolute number of germinated conidia were observed, the most similar effect to the Control Agent.
C9: a low absolute number of germinated conidia were observed.

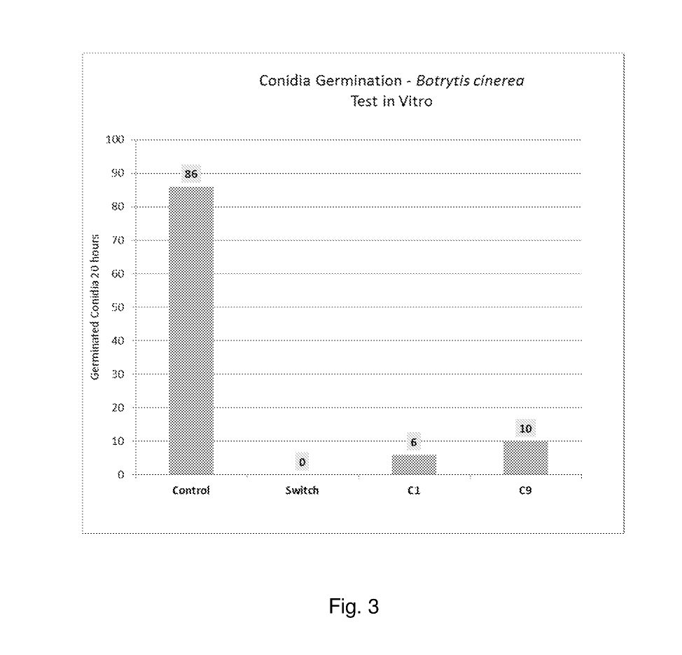

See FIG. 3 for a schematic view of the results.

In the second test, the biological efficacies of the following treatments were compared after 20 hours:
Control (water): a very high number of germinated conidia was noted;
Switch® (a.i. Cyprodinil and Fludioxonil) (0.194% p/v): a low number of germinated conidia were observed;
C2: a low absolute number of germinated conidia were observed.
C3: a very low absolute number of germinated conidia were observed, the most similar effect to the Control Agent.
C4: a low absolute number of germinated conidia were observed.
C5: a low absolute number of germinated conidia were observed.
C6: a low absolute number of germinated conidia were observed.
C7: a low absolute number of germinated conidia were observed.
C8: a low absolute number of germinated conidia were observed.

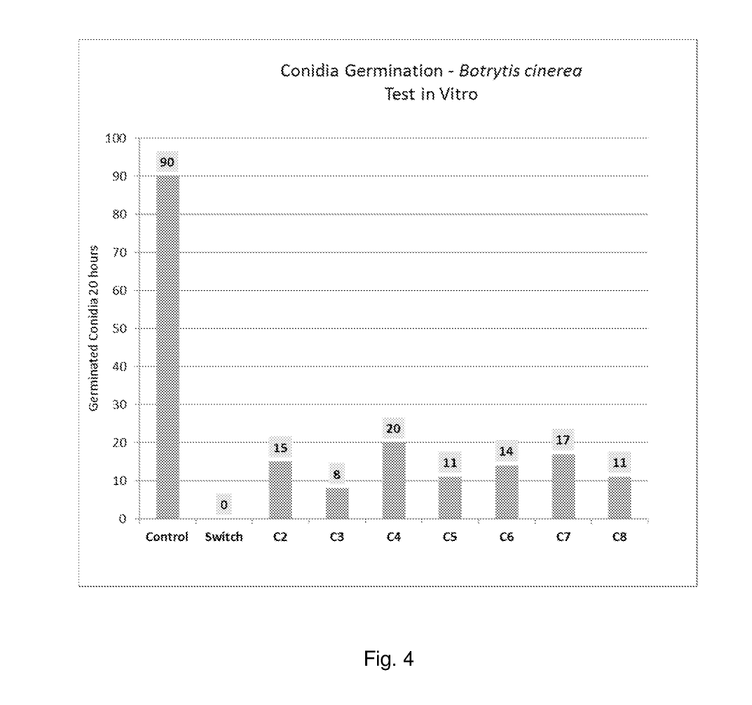

See FIG. 4 for a schematic view of the results.

3. ESCA or Grapevine Trunk Disease

Samples constituted of water and based on Carbonate Hydroxyapatite (HCA) loaded with vegetal extracts were tested in vitro against the pathogens related to esca: Phaeomoniella chlamydospora, Phaeoacremonium aleophilum, Fomitiporia mediterranea.

The protocol consisted on the pathogens growth in a proper media (PDA, Difco) as untreated sample, and the same media with 3 different concentrations of the testing agents, 1.2%, 2.4% and 4.8%; and the same media with the Bordeaux mixture based on copper (p.a. 0.02%) as comparison agent.

The first day (0) each pathogen was inoculated by placing a colony (0.5 cm diam.) in the centre of petri dishes (6 cm diam.) containing the media already prepared with the testing agents. Petri dishes were closed by Parafilm and placed into an incubation chamber at 22±1° C. alternating light/dark during the incubation period.

Per each pathogen 11 petri dishes were prepared (3 samples×3 concentrations+2 controls) and per one of each, 10 replications.

The measurement of the diameter of colonization was done weekly. Deducing to these values, the nominal value of 0.5 cm correspondent to the initial colony inoculated, the effective colony growth was obtained. The efficacy index per each product was calculated considering the effective fungal colony growth, applying the formula below:

$$E = \frac{[ value of growth ( {sample}_{11}^{2} ) - value of growth ( sample 1 ) ]}{value of growth ( sample 1 )} \times 100$$

where sample 1=control

In the table 1, 2 and 3, the measures of the colony growth are summarised, referred to the diameter of growth of each pathogen after the incubation period on the PDA media without any agent and add of each testing agent in 3 different concentrations and the comparison agent. Next to these, their efficacy values are reported.

In the table 1 the average diameter and the efficacy value are listed for Fomitiporia mediterranea after 7 and 14 days of incubations.

All the testing agents showed a inhibitor action on the fungal growth in all concentrations tested and during the entire period of incubation.

TABLE 1
Diameters (diam.) in cm, of Fomitiporia mediterranea (Fm) colony
on PDA containing the 3 testing agents at 3 concentrations 1.2%,
2.4% and 4.8%; detecting, after 7 days and 14 days of incubation,
the efficacy (E) in %. As control agents, a PDA without any agent
and a PDA with an agent based on copper 0.02% p.a., were used.

| | control | comparison ag. | | C3 | | C1 | | C9 | |
|---|---|---|---|---|---|---|---|---|---|
| Fm | diam | diam | E | diam | E | diam | E | diam | E |
| 1.2% | | | | | | | | | |
| 7 days | 1.63 | 0.53 | 96.65 | 0.58 | 93.72 | 0.50 | 100 | 0.50 | 100 |
| 14 days | 5.10 | 0.75 | 93.82 | 0.70 | 89.41 | 0.50 | 100 | 0.50 | 100 |
| 2.4% | | | | | | | | | |
| 7 days | 1.63 | 0.53 | 96.65 | 0.50 | 100 | 0.50 | 100 | 0.50 | 100 |
| 14 days | 5.10 | 0.75 | 93.82 | 0.50 | 100 | 0.50 | 100 | 0.50 | 100 |
| 4.8% | | | | | | | | | |
| 7 days | 1.63 | 0.53 | 96.65 | 0.50 | 100 | 0.50 | 100 | 0.50 | 100 |
| 14 days | 5.10 | 0.75 | 93.82 | 0.50 | 100 | 0.50 | 100 | 0.50 | 100 |

In the table 2 the average diameter and the efficacy value are listed for Phaeomoniella chlamydospora (Pch) after 7, 14 and 21 days of incubations.

All the testing agents have completely inhibited the fungal growth after 7 days of incubation.

All the testing agents were efficacy at 100% against Phaeomoniella chlamydospora (Pch) at the concentration of 4.8%.

TABLE 2
Diameters (diam.) in cm, of Phaeomoniella chlamydospora (Pch) colony
on PDA containing the 3 testing agents at 3 concentrations 1.2%, 2.4%
and 4.8%; detecting, after 7, 14 and 21 days of incubation, the efficacy
(E) in %. As control agents, a PDA without any agent and a PDA with
an agent based on copper 0.02% p.a., were used.

| | control | comparison ag. | | C3 | | C1 | | C9 | |
|---|---|---|---|---|---|---|---|---|---|
| Fm | diam | diam | E | diam | E | diam | E | diam | E |
| 1.2% | | | | | | | | | |
| 7 days | 1.38 | 1.48 | 6.85 | 0.50 | 100 | 0.50 | 100 | 0.50 | 100 |
| 14 days | 3.01 | 2.24 | 25.91 | 0.71 | 90.05 | 0.50 | 100 | 0.50 | 100 |
| 21 days | 5.10 | 2.87 | 49.56 | 1.02 | 86.97 | 0.50 | 100 | 0.50 | 100 |
| 2.4% | | | | | | | | | |
| 7 days | 1.38 | 1.48 | 6.85 | 0.50 | 100 | 0.50 | 100 | 0.50 | 100 |
| 14 days | 3.01 | 2.24 | 25.91 | 0.54 | 99.16 | 0.50 | 100 | 0.50 | 100 |
| 21 days | 5.10 | 2.87 | 49.56 | 0.59 | 98.06 | 0.50 | 100 | 0.50 | 100 |
| 4.8% | | | | | | | | | |
| 7 days | 1.38 | 1.48 | 6.85 | 0.50 | 100 | 0.50 | 100 | 0.50 | 100 |
| 14 days | 3.01 | 2.24 | 25.91 | 0.50 | 100 | 0.50 | 100 | 0.50 | 100 |

In the Table 3 the average diameter and the efficacy value are listed for Phaeoacremonium aleophilum (Pal), after 14, 21 and 28 days of incubations.

TABLE 3
Diameters (diam.) in cm, Phaeoacremonium aleophilum (Pal) colony
on PDA containing the 3 testing agents at 3 concentrations 1.2%, 2.4%
and 4.8%; detecting, after 7, 14, 21 and 28 days of incubation, the
efficacy (E) in %. As control agents, a PDA without any agent and
a PDA with an agent based on copper 0.02% p.a., were used.

| | control | comparison ag. | | C3 | | C1 | | C9 | |
|---|---|---|---|---|---|---|---|---|---|
| Fm | diam | diam | E | diam | E | diam | E | diam | E |
| 1.2% | | | | | | | | | |
| 7 days | 1.23 | 0.50 | 100 | 0.50 | 100 | 0.50 | 100 | 0.50 | 100 |
| 14 days | 2.15 | 0.50 | 100 | 0.50 | 100 | 0.50 | 100 | 0.50 | 100 |
| 21 days | 3.12 | 0.70 | 92.61 | 0.50 | 100 | 0.50 | 100 | 0.50 | 100 |
| 28 days | 4.01 | 0.97 | 81.04 | 0.50 | 100 | 0.50 | 100 | 0.50 | 100 |
| 2.4% | | | | | | | | | |
| 7 days | 1.23 | 0.50 | 100 | 0.50 | 100 | 0.50 | 100 | 0.50 | 100 |
| 14 days | 2.15 | 0.50 | 100 | 0.50 | 100 | 0.50 | 100 | 0.50 | 100 |
| 21 days | 3.12 | 0.70 | 92.61 | 0.50 | 100 | 0.50 | 100 | 0.50 | 100 |
| 28 days | 4.01 | 0.97 | 81.04 | 0.50 | 100 | 0.50 | 100 | 0.50 | 100 |
| 4.8% | | | | | | | | | |
| 7 days | 1.23 | 0.50 | 100 | 0.50 | 100 | 0.50 | 100 | 0.50 | 100 |
| 14 days | 2.15 | 0.50 | 100 | 0.50 | 100 | 0.50 | 100 | 0.50 | 100 |
| 21 days | 3.12 | 0.70 | 92.61 | 0.50 | 100 | 0.50 | 100 | 0.50 | 100 |
| 28 days | 4.01 | 0.97 | 81.04 | 0.50 | 100 | 0.50 | 100 | 0.50 | 100 |

In conclusion, all the three samples tested, C3, C1, C9, by the present vitro test, were efficacy against the three fungal pathogens related to Esca disease of grapevine (GTDs), inhibiting their growth in the majority thesis in comparison.

### Examples B

Experimental Tests on Vine Diseases

LEGEND OF THE TESTED FORMULATIONS
All the formulations contain water, hydroxyapatite substituted with
carbonate ions and/or copper and/or zinc, and functionalized
with ions (K, Mg, B, Mn) and/or vegetal extracts.

| Code | Functional (F) or substituent (S) substances (g/kg formulation) |
|---|---|
| C1 | Cu = 50 (S); Zn (S) = 18; mix of vegetal extracts = 30 (F) |
| C2 | Vegetal extract of Lemon = 30 (F) |
| C3 | Vegetal extract of Cloves = 30 (F) |
| C4 | Vegetal extract of Peppermint = 30 (F) |
| C5 | Vegetal extract of Thyme = 30 (F) |
| C6 | Vegetal extract of Rosemary = 30 (F) |
| C7 | Vegetal extract of Garlic = 30 (F) |
| C8 | Vegetal extract of Cinnamon = 30 (F) |
| C9 | mix of vegetal extracts = 30 (F) |
| T1 | Cu [sulphate] = 35 (F); Zn (F) = 18; |
| | mix of vegetal extracts = 30 (F) |
| T2 | Cu [sulphate tribasic] = 35 (F); Zn (F) = 18; |
| | mix of vegetal extracts = 30 (F) |
| T3 | Cu [oxychloride] = 35 (F); Zn (F) = 18; |
| | mix of vegetal extracts = 30 (F) |
| T4 | Cu [hydroxide] = 35 (F); Zn (F) = 18; |
| | mix of vegetal extracts = 30 (F) |
| MS | Hydroxyapatite substituted with carbonate ions = 120 |

1. Introduction

Several formulations based on hydroxyapatite substituted with carbonate ions and/or copper and/or zinc, and functionalized with vegetal extracts were tested in vitro and in vivo against grapevine pathogens.

2. Grey Mould (Botrytis cinerea) and ESCA or Grapevine Trunk Disease

Samples constituted of water and based on Carbonate Hydroxyapatite (HCA) loaded with vegetal extracts were tested in vitro against the pathogens related to esca and grey mould: Phaeomoniella chlamydospora, Phaeoacremonium aleophilum, Botrytis cinerea. The protocol consisted on the pathogens growth in a proper media (MEA—Malt Extract Agar) as untreated sample, and the same media with 4 different concentrations of the testing agents, 0.6%, 1.2%, 2.4% and 4.8.

The fungal growth was measured, in the diametrical direction, from the inoculation point. The measurement was expressed in mm. Given the excessive growth difference of the three tested fungi, the measurements were set differently: Botrytis cinerea, with rapid growth, it was monitored every 24 hours for the first five days, at the end of which the control had completely filled the plate, while Phaeoacremonium aleophilum and Phaeomoniella chlamydospora were observed every 7 days for four weeks (then at 7, 14, 21 and 28 days).

Subtracting to the values, the diametric value 0.7 mm, corresponding to the initial inoculum, it was determined the actual growth of the colony; however, the effectiveness of the single product was calculated observing (Moghaddam et al, 2014) the percentage of growth inhibition compared to the control (abbreviated % IG), by the formula:

% IG=[Growth value inoculated sample−Growth value control]/Growth value control

In order to improve the information on the data relating to the effect of these treatments were subjected to analysis of variance (ANOVA) and the significance of the differences between the averages of the treatments was tested by the Tukey's HSD Test. The package used for the ‘Statistical analysis of the results was 10 version developed by StatSoft. Inc., Tulsa, Okla. 74104 USA.

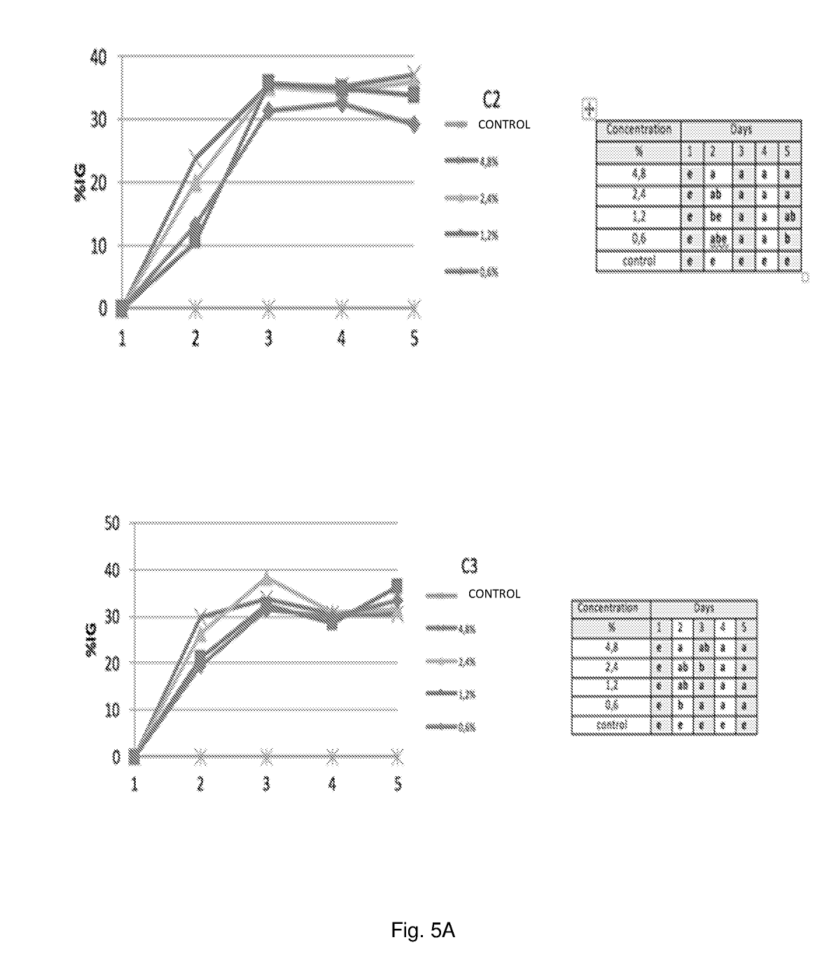

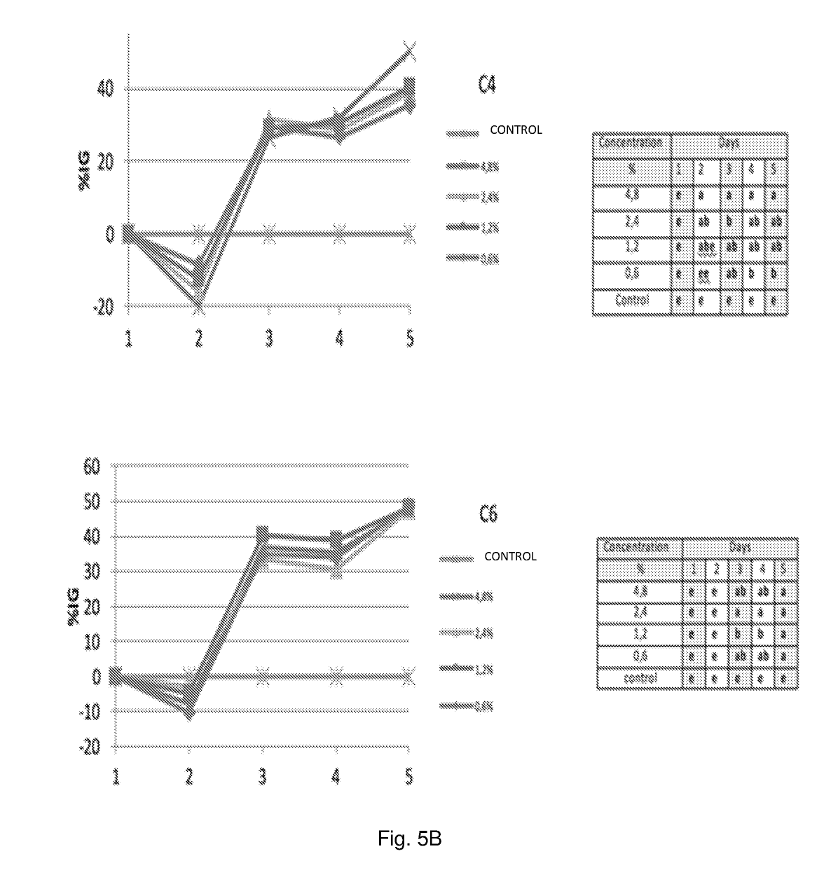

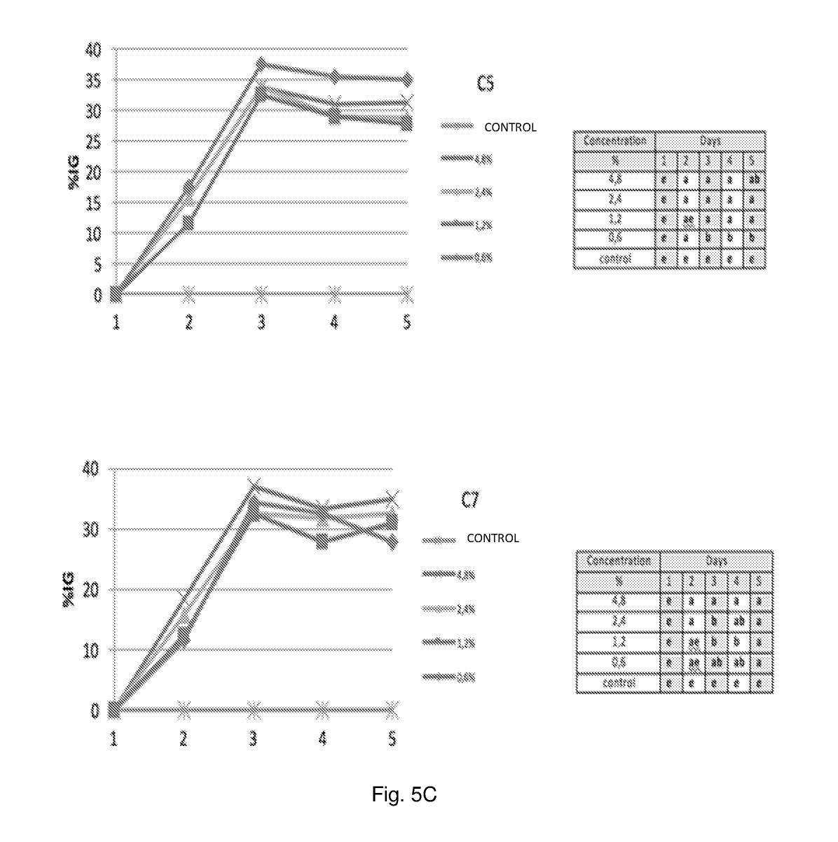

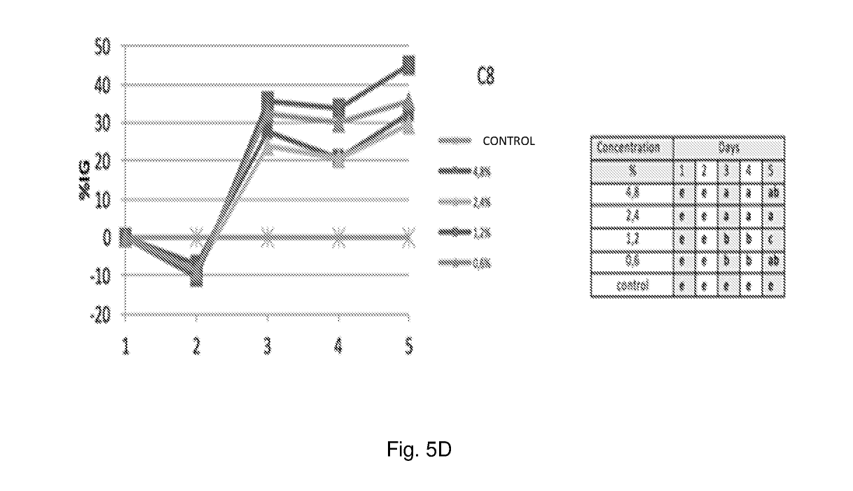

Results on Grey Mould (Botrytis cinerea)—FIGS. 5A-D

The treatment with C8 shows a statistically significant inhibitory effect from the 2^{nd} day at all concentrations. The sample C4 showed a similar control to the previous extract, showing also in this case, to inhibit the growth of the fungus over 40%.

The treatment C6, also shows an inhibitory effect, from the 2^{nd} day. The treatment with C3 proves to have a inhibitory effect of growth already at the 2^{nd} day for all concentrations, which was not the case in previous treatments. It is observed that treatments C5 and C7 have an inhibitory effect on the fungus that is, as in the case C7, statistically significant at the 2^{nd} day. The treatment C2 inhibits significantly the fungus from the 3^{rd} day.

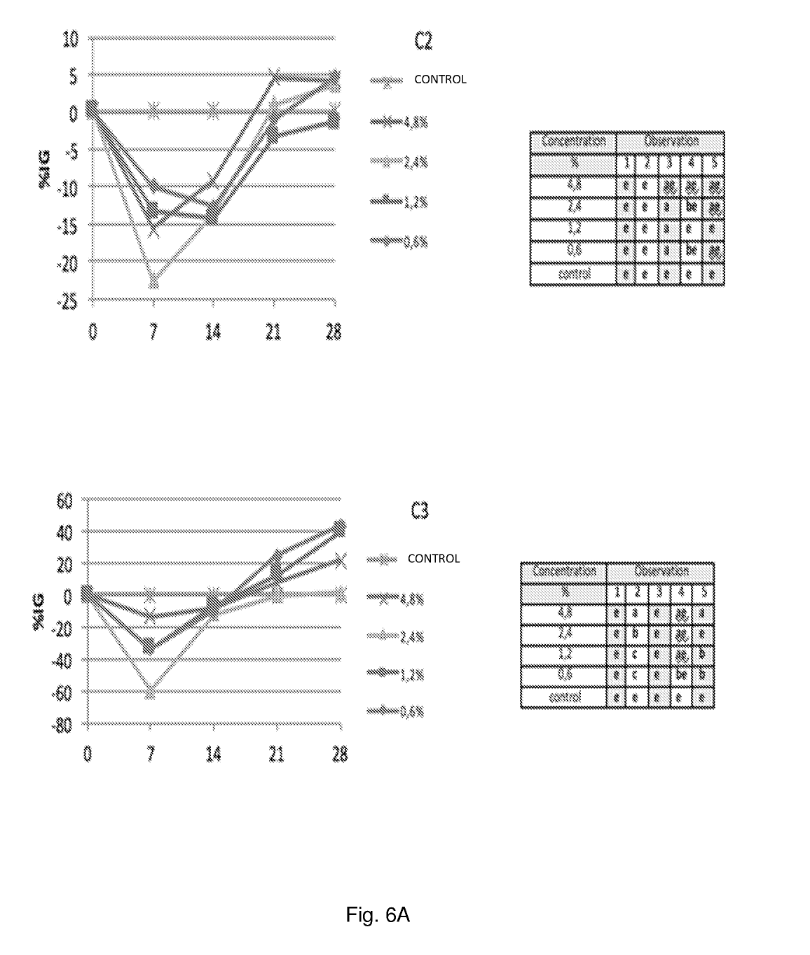

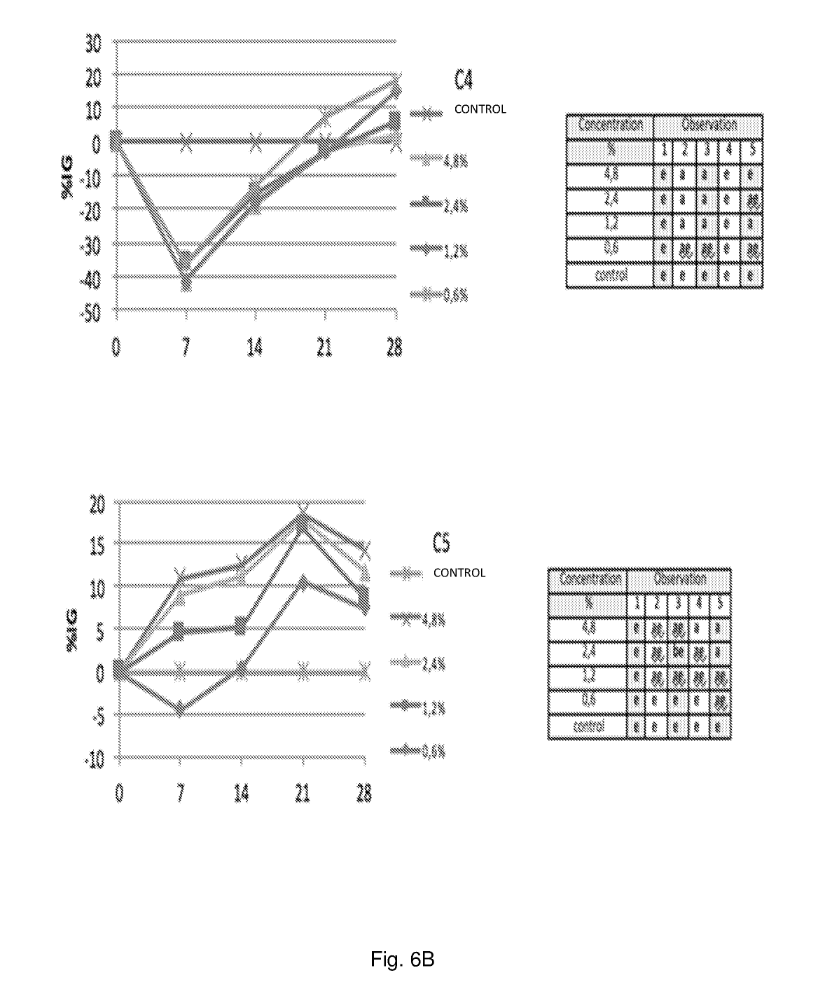

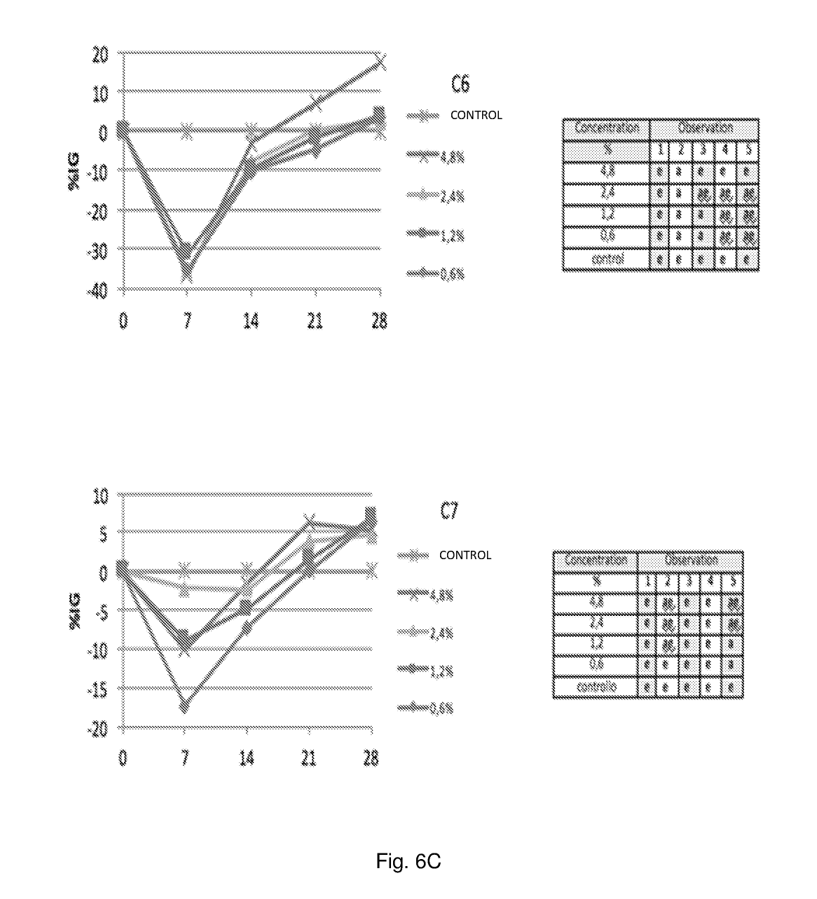

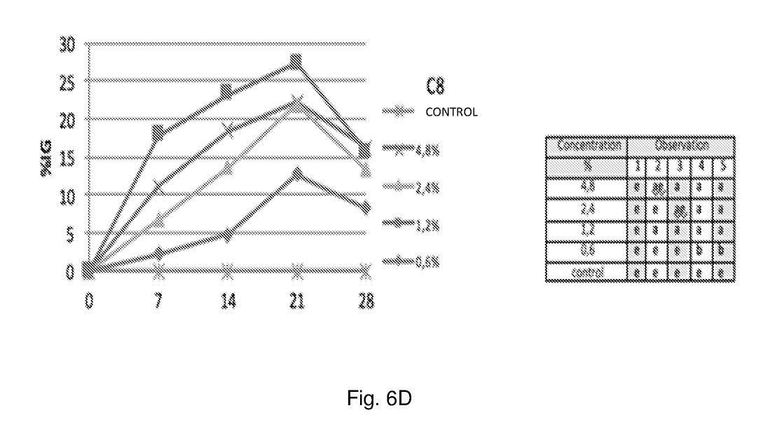

Results ESCA (Phaeomoniella chlamydospora)—FIGS. 6A-D

Treatment C8 has an inhibitory effect, for the very high concentrations, already at day 7. This effect increases with time coming, for the 1.2% concentration, by day 2, at 27%. C4 and C6 show a probiotic effect, immediately observed at day 7, which tends to decrease during the test reporting day 21. About treatment C3, on the 28^{th} day, it has an inhibitory effect, which also exceeds 40%, for the concentrations 4.8%, 1.2% and 0.6%. Treatment C7 shows a similar trend to the previous treatment. Treatment C5 showed a development equal in the first 14 day, the inhibition effect was seen only for the highest concentrations of 4.8% and 2.4%. Treatment C2 showed an inhibitory effect of about 5% toward the end of the growth that could be indicate a long-term effect. Globally the treatments revealed a probiotic effect in the short-time period then followed by a progress inhibition of the fungi in the long-time period: this confirm the nutraceutical role of the vegetal extract, here amplified by the combination with HCA.

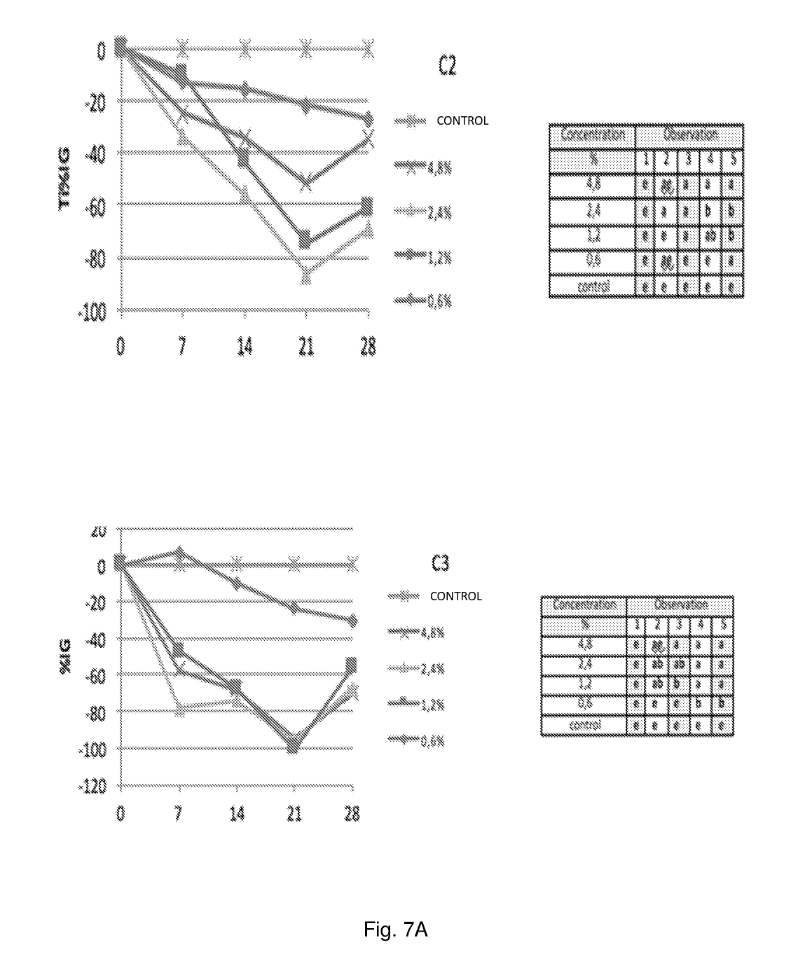

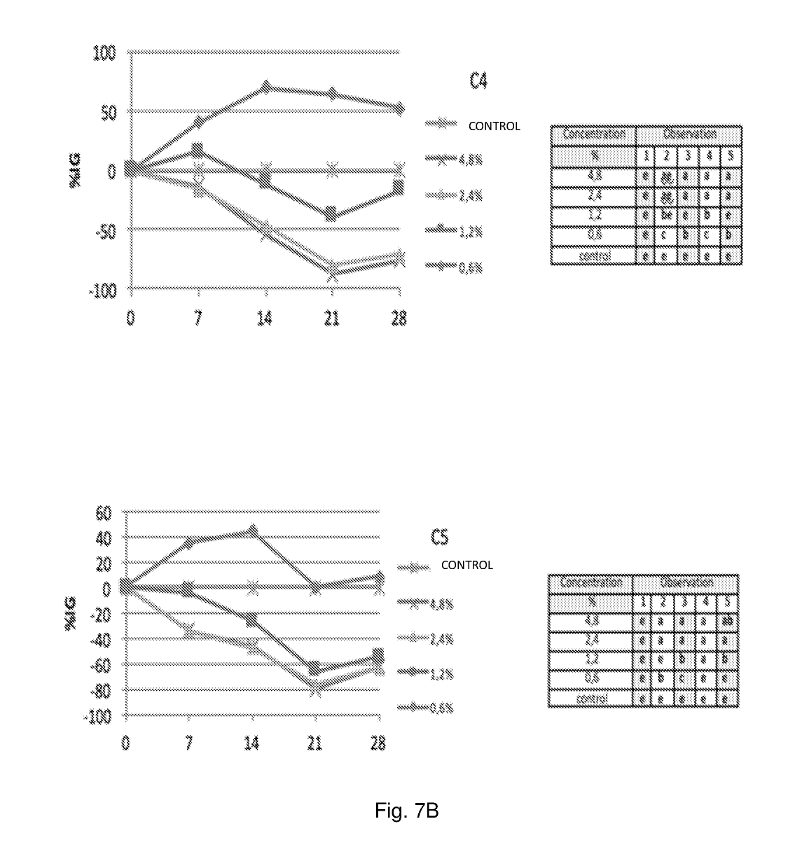

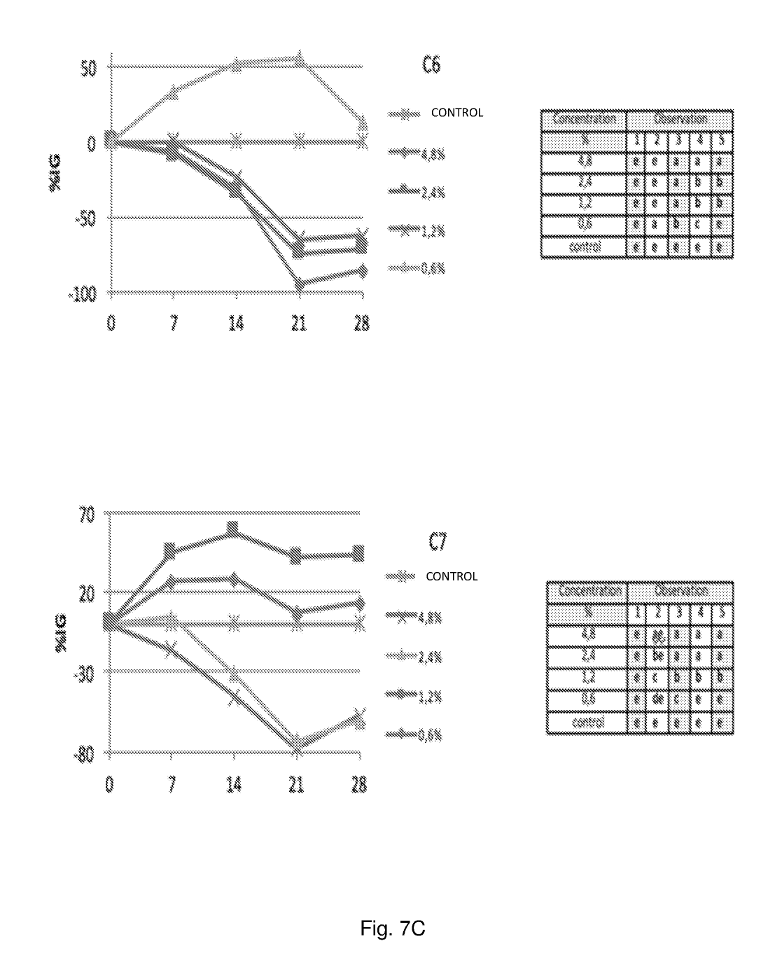

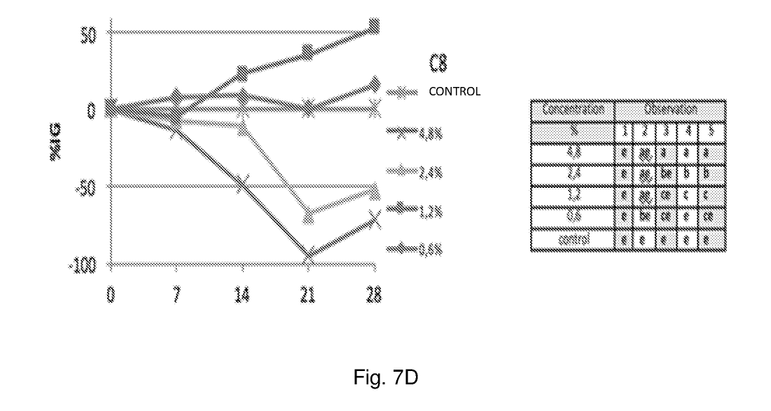

Results ESCA (Phaeoacremonium aleophilum)—FIGS. 7A-D

Treatment C8 revealed a probiotic effect from day 14 for the very high concentrations, at day 21, while for the 1.2% a constant inhibitory effect was reported. The same trend was also reported by the treatment C4 and C6, at the concentration of 0.6%. For the treatment C3, the concentration 0.6% departs from the others assuming an initial inhibition then turned into a probiotic effect. The concentration 1.2%, of the treatment C7, inhibits the fungus up to 56% IG at day 14, while the treatment C5, at concentration 0.6%, has an inhibitory effect immediately but that tends to decrease over time. About the treatment C2, it is noted that all concentrations induce a probiotic effect, which increases up to 21 days after which the highest concentrations decrease this effect. As reported for Phaeomoniella chlamydospora, the general short-term probiotic effect noted for high concentrations of the treatments, confirms the nutraceutical role of the vegetal extracts, in controlling the growth of the fungi in the long-term period, without destroying the fungal cell (as some synthetic fungicide act) but interfering with its fertility in the time.

3. Downy Mildew (Plasmopara viticola)

Samples constituted of water and based on Carbonate Hydroxyapatite (HCA) loaded with several copper salts (sulphate, tribasic sulphate, oxychloride, hydroxide), zinc sulphate and vegetal extracts were tested in vivo against Plasmopara viticola.

The greenhouse test was performed to evaluate the protective efficacy of the test agents applied at the concentration of 1% v/v. To conduct this test, 6 potted vines were employed per each treatment: control (water), comparison agent and test agents.

Potted vines were selected for adequate height, good health status and number of unfolded leaves (minimum five). They were prepared for the treatment, tying the shoot just above the first five leaves eligible for the final disease assessment.

On day “1” potted vines were treated with a handle sprayer and after 24 hours the inoculation of the fungal pathogen was performed on the treated plants. The inoculum was prepared collecting leaves with fresh and prominent symptoms of Plasmopara viticola from infected potted vines grown in the greenhouse. Infected leaves were washed by water, manually sprayed on the low surface, in order to get an aqueous solution rich in sporangia. Sporangia concentration was adjusted in a Thoma® chamber at the microscope (magnification 40×), to 1*10⁶ sporangia/ml (minimum). The sporangia suspension was sprayed manually on the treated plants taking care to wet the lower surface of the five leaves below the tying point of the shoot homogeneously.

After inoculation, the table with potted vines was covered with a black plastic tarp and left in the cellar for the first day of incubation. In order to evaluate the curative efficacy of the test agents, inoculation with P. viticola was conducted at the first day and after 24 hours of incubation the treatments were performed (once the surface of the leaves was as dry as possible). The third day, the treated, inoculated and incubated plants were uncovered and transferred and cultivated into the greenhouse under controlled growth conditions.

The eighth day, potted vines were abundantly wet, spraying water on the foliage, then, they were covered again with a black plastic tarp and transferred into the cellar to favour sporulation.

After 24 hours, the plants were uncovered. The disease severity was determined by observing the five leaves below the tying point of the shoot in each potted vine.

In order to improve the information on the data relating to the effect of these treatments were subjected to analysis of variance (ANOVA) and the significance of the differences between the averages of the treatments was tested by the Tukey's HSD Test. The package used for the ‘Statistical analysis of the results was 10 version developed by StatSoft. Inc., Tulsa, Okla. 74104 USA.

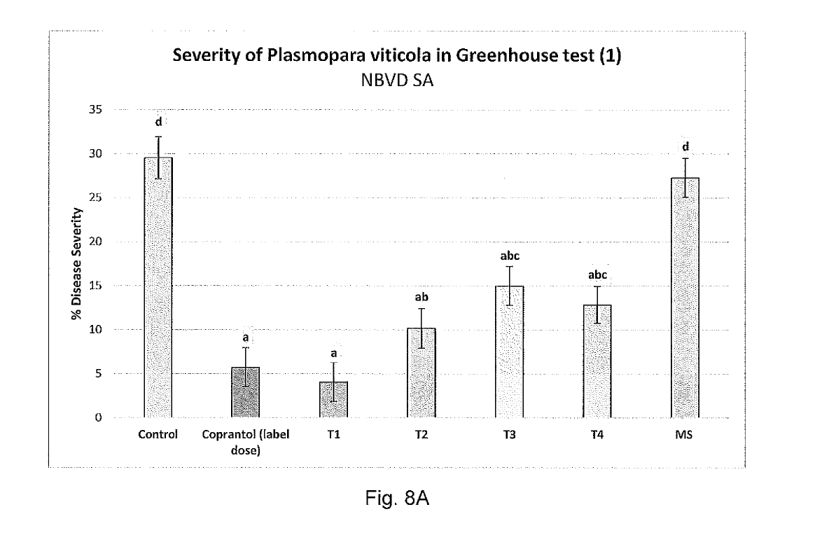

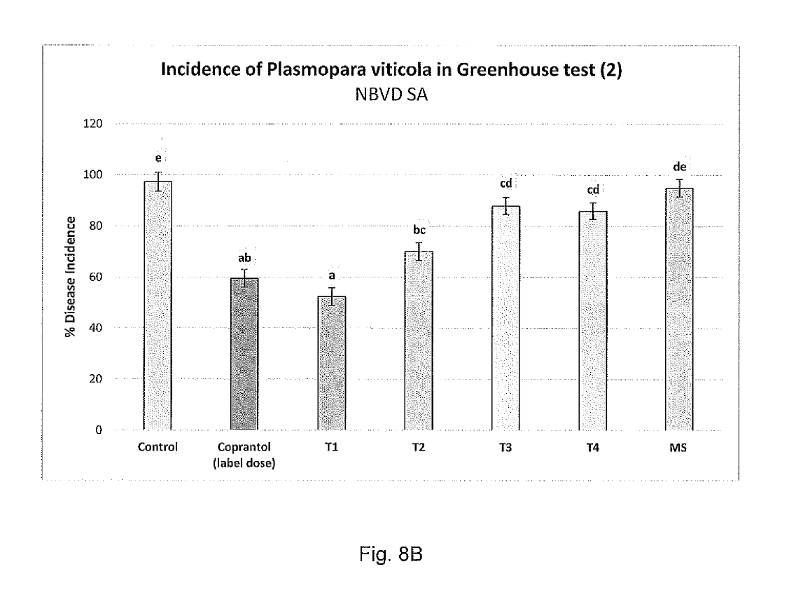

Results on Downy Mildew (Plasmopara viticola)—FIGS. 8A-D

As reported by the FIG. 4, the test was considering highly significant due to the high disease expression by the control.

The pure HCA did not interfere significantly the fungal growth, even if in absolute value, the treatment MS showed a disease severity lower than the control.

While HCA with each one of the four copper salts combined with zinc sulphate and vegetal extracts revealed a good control of the fungal growth: the disease severity was particularly low in the plants treated with T1 and T2. Both ones showed also the lowest disease incidence if compared with the control agent (Coprantol®). The disease was partially controlled by T3 and T4.

Globally the test revealed a very good performance for T1 and T2 on the Plasmopara viticola control, in vivo test.

1. A carrier loaded with at least one bioactive substance,
wherein the carrier is carbonate substituted hydroxyapatite
and
the at least one bioactive substance is selected from the group consisting of an ion and a plant extract, wherein said ion is selected from the group consisting of Mn, Mg, K, Fe and B and wherein said vegetal extract is selected from in the group consisting of an extract of: lignin, mint, thyme, rosemary, sesame, soya, cloves, garlic, lemon, cinnamon, Abies sibirica, Malpighia glabra, Achillea millefolium. Allium sativum, Medicago sativa, Aloe vera Citrus sinensis, Artemisia annua, Arnica Montana, Ocimum basilicum, Betula pendula, Betula pubescens, Calendula officinalis, Matricaria chamomilla, Chamaemelum nobile, Cinnamomum verum, Centella asiatica, Chelidonium majus, Syzygium aromaticum, Allium cepa, Equisetum arvense, Curcuma longa, Echinacea purpurea, Echinacea angustifolia, Eucalyptus globulus, Hypericum perforatum, Fucus vesiculosus, Gentiana lutea, Lavandula angustifolia, Citrus limon, Melilotus officinalis, Melissa officinalis, Punica granatum, Mentha piperita, Vaccinium myrtillus, Orthosiphon stamineus, Urtica dioica, Olea europeae, Tabebuia impetiginosa, Plantago lanceolata, Hieracium pilosella, Pinus sibirica, Polypodium leucotoms, Citrus paradise, Quassia amara, Rheum Thais, Rosa canina, Rosmarinus officinalis, Ruscus aculeatus, Salix alba, Salvia officinalis, Camelia sinensis, Tilia tomentosa, Thymus vulgaris, Arctostaphylos uva-ursi, Valeriana officinalis, Solidago virgaurea, Loranthus europaeus and Zingiber officinale.

2. The loaded carrier according to claim 1, wherein the hydroxyapatite is substituted with carbonate ions only or metal ions only or a mixture of carbonate and metal ions.

3. The loaded carrier according to claim 1, in the form of an aggregate of substituted hydroxyapatite particles, wherein the aggregate has a size comprised between 0.5 and 5 μm.

4. The loaded carrier according to claim 1, wherein the vegetal extract is used in the form of a powder or an alcoholic or hydro-alcoholic solution.

5. A composition comprising the loaded carrier according to claim 1, in a quantity of 5-70% in relation to the total weight of dry material of the composition.

6. Method for treating or preventing plant diseases in plants with a carrier loaded with at least one bioactive substance according to claim 1, said method comprising: applying said loaded carrier on said plants

7. The method according to claim 6, wherein the plants are grapevines, tomato plant, Solanum lycopersicum, wheat, Triticum spp, pear tree, Pyrus spp, apple tree, Malus domestica, olive tree, Olea europaea, kiwifruit, Actinia spp and vegetable plants.

8. The method according to claim 6, wherein the bioactive substance has an anti-parasite activity against cryptogams, bacteria, fungi, phytoplasma and insects and/or a nutritional activity as fertilizer or growth enhancer.

9. The method according to claim 8, wherein the anti-parasite activity of the bioactive substance is for the prevention and treatment of downey mildew caused by Plasmopara viticola, powdery mildew caused by Erysiphe nectar, Grey mould caused by Botrytis cinerea, black rot caused by Guignardia bidwellii, grapevine crown gall caused by Agrobacterium vitis, grapevine trunk diseases or esca caused by Botryosphaeriaceae, Phaeomoniella chlamydospora, Phaeoacremonium aleophilum, Fomitiporia mediterranea late blight of tomatoes caused by Phytophthora infestans, fusarium head blight of wheat caused by Fusarium graminearum and Fusarium culmorum, apple scab caused by Venturia inaequalis, pear scab caused by Venturia pirina, brown spot of pear caused by Stemphylium vesicarium, Lettuce mildew caused by Bremia lactucae, Spinach mildew caused by Peronospora spinaceae, Cucurbits mildew caused by Pseudoperonospora cubensis on cantaloupe, cucumber, pumpkin, squash and watermelon, Onion mildew caused by Peronospora schleideni, Leek mildew caused by Phytophtora porri, Peas mildew caused by Peronospora pisi, diseases caused by the insects: European grapevine moths Eupoecilia ambiguella and vine mealybug Planococcus ficus.

10. The loaded carrier according to claim 1, wherein the carbonate-substituted hydroxyapatite has the following formula:
Ca₍₁₀₎(PO₄)_{(6-y)}(CO₃)_{y}(OH)₂
wherein y is comprised between 0.002 and 0.030.
